(19) United States
(12) Patent Application Publication
(10) Pub. No.: US 2026/0368711 A1
(43) Pub. Date: Nov. 19, 2026

(54) CONTENT GENERATION IN A DISPENSING ENVIRONMENT

(71) Applicant: Wayne Fueling Systems LLC, Austin, TX (US)

(72) Inventors: Bradford Loewy, Marietta, GA (US); John Joseph Morris, Leander, TX (US); Rohith Chinnaswamy, Round Rock, TX (US)

(21) Appl. No.: 19/673,519

(22) Filed: May 11, 2026

Related U.S. Application Data
(60) Provisional application No. 63/805,049, filed on May 13, 2025.

(51) Int. Cl. G06Q 20/18

(52) U.S. Cl. CPC G06Q 20/18

(57) ABSTRACT

A method for generating content data in a dispensing environment can include receiving, by a data processor of a point-of-sale system communicably coupled to a product dispenser configured in a dispensing environment, a request for a web page to be displayed via a display of the product dispenser. The web page providing one or more selections of at least one good or service within the dispensing environment. Data characterizing the web page and content data contextually associated with the at least one good or service can be determined and can be dynamically generated in a memory of the point-of-sale system based on receiving the request for the web page and the web page including the content data can be generated by the data processor and transmitted to the product dispenser for display via the display of the product dispenser. Related systems and computer-readable mediums are also provided.

### CROSS-REFERENCE TO RELATED APPLICATIONS

This application claims the benefit of priority to U.S. Provisional Application No, 63/805,049, filed on May 13, 2025, entitled “CONTENT generation IN A DISPENSING ENVIRONMENT,” the entire contents of which is hereby incorporated by reference in its entirety.

### FIELD

The current subject matter relates to methods and systems for determining and generating content data in a dispensing environment.

### BACKGROUND

The subject matter herein pertains to the adaptive determination and provision of content data in a dispensing environment. The content data can be determined based on user data, vehicle data, and goods or services available for purchase in the dispensing environment. The content data can be dynamically determined based on pricing logic configured in a point-of-sale system of the dispensing environment. The content data can be presented to the user via a display of a dispenser in the dispensing environment or via a printed offer.

### SUMMARY

Exemplary systems, methods, and non-transient, computer-readable mediums configured to generate content data in a dispensing environment are provided. In one aspect, a method is provided and in one embodiment, the method can include receiving, by a data processor of a point-of-sale system communicably coupled to a product dispenser configured in a dispensing environment, a request for a web page to be displayed via a display of the product dispenser. The web page can provide one or more selections of at least one good or service available within the dispensing environment. The method can also include determining, by the data processor, data characterizing the web page and content data contextually associated with the at least one good or service. The data characterizing the web page and the content data can be dynamically generated in a memory of the point-of-sale system based on receiving the request for the web page. The method can further include generating, by the data processor, the web page including the content data. The method can also include causing, by the data processor, the web page including the content data to be transmitted to the product dispenser for display via the display.

Additional embodiments can also be provided. For example, in one embodiment, responsive to the product dispenser receiving a selection of the at least one good or service via the displayed web page and transmitting the selection to the point-of-sale system, the data processor can be further configured to determine a transaction record including transaction data associated with the selection and transmit the transaction record to the product dispenser for display via the display. In another embodiment, the transaction record can further include transaction data associated with a dispensing operation performed at the product dispenser when the request for the web page is received by the data processor of the point-of-sale system. In yet another embodiment, the transaction record can further include an optically scannable element associated with the at least one good or service and/or the dispensing operation. The optically scannable element can include one of bar code and a quick response code. In another embodiment, the point-of-sale system can be configured to process the optically scannable element for redemption of the at least one good or service in the dispensing environment.

In another embodiment, the content data can be formatted in one of a JavaScript object notation format or an extensible markup language format. In yet another embodiment, the product dispenser can further include an image sensor configured to acquire image data characterizing one of a user of product dispenser and a vehicle positioned at the product dispenser and a communication interface configured to transmit the image data to the data processor. Once received, the data processor can be further configured determine the content data based on the received image data. In one embodiment, the product dispenser can be configured to dispense at least one of electricity, petroleum fuel, diesel exhaust fluid, compressed natural gas, liquified natural gas, or hydrogen. In another embodiment, the product dispenser can further include a printer configured to provide the transaction record as a paper transaction record. In yet another embodiment, the data processor can be further configured to transmit a digital transaction record to a mobile device of a user of the product dispenser.

In another aspect, a product dispenser is provided and in one embodiment, the product dispenser can include a first housing including product dispensing components operable to dispense a product from the product dispenser and a second housing including a data processor, a memory storing executable instructions, a display, a communication interface, and an image sensor. The data processor can be configured to execute the instructions stored in the memory to cause the data processor to perform operations comprising initiating a dispensing operation to dispense the product via the dispensing components. The operations can also include generating a request for a web page to be displayed via the display. The request can be generated in response to initiating the dispensing operation and the web page providing one or more selections of at least one good or service available within a dispensing environment in which the product dispenser is located. The operations can also include causing the request to be transmitted via the communication interface to a point-of-sale system having a data processor configured to determine data characterizing the web page and content data contextually associated with the at least one good or service. The data characterizing the web page and the content data can be dynamically generated in a memory of the point-of-sale system based on receiving the request for the web page The point-of-sale system can be configured to generate and transmit the web page including the content data to the product dispenser. The operations can further include receiving, via the communication interface, the web page including the content data from the point-of-sale system and causing the web page including the content data to be displayed via the display.

Additional embodiments can also be provided. For example, in one embodiment, responsive to the data processor receiving a selection of the at least one good or service via the displayed web page and causing the selection to be transmitted via the communication interface to the point-of-sale system, the data processor of the point-of-sale system can be further configured to determine a transaction record including transaction data associated with the selection and cause the transaction record to be transmitted to the data processor of the product dispenser for display via the display. In another embodiment, the transaction record can further include transaction data associated with the dispensing operation. In yet another embodiment, the transaction record can further include an optically scannable element associated with the at least one good or service and/or the dispensing operation. The optically scannable element can include one of bar code and a quick response code. In a further embodiment, the data processor of the point-of-sale system can be configured to process the optically scannable element for redemption of the at least one good or service in the dispensing environment.

In another embodiment, the content data can be formatted in one of a JavaScript object notation format or an extensible markup language format. In one embodiment, the image sensor can be configured to acquire image data characterizing one of a user of product dispenser and a vehicle positioned at the product dispenser and the communication interface is configured to transmit the image data to the data processor of the point-of-sale system. Once received the data processor of the point-of-sale system can be further configured determine the content data based on the received image data. In another embodiment, the product dispenser can be configured to dispense at least one of electricity, petroleum fuel, diesel exhaust fluid, compressed natural gas, liquified natural gas, or hydrogen. In a further embodiment, the product dispenser can further include a printer and the data processor of the product dispenser can be further configured to provide the transaction record as a paper transaction record. In one embodiment, the data processor of the point-of-sale system can be further configured to transmit a digital transaction record to a mobile device of a user of the product dispenser.

### BRIEF DESCRIPTION OF DRAWINGS

The details of one or more variations of the subject matter described herein are set forth in the accompanying drawings and the description below. Other features and advantages of the subject matter described herein will be apparent from the description and drawings, and from the claims. The embodiments described above will be more fully understood from the following detailed description taken in conjunction with the accompanying drawings. The drawings are not intended to be drawn to scale. For purposes of clarity, not every component may be labeled in every drawing. In the drawings:

FIG. 1 is a diagram illustrating an example embodiment of a system for generating content data in a dispensing environment according to the subject matter described herein;

FIG. 2 is a diagram illustrating an example embodiment of a dataflow of the system of FIG. 1 for generating content data according to the subject matter described herein;

FIG. 3 is a process diagram illustrating an example embodiment of a method for generating content data performed using the system of FIG. 1 according to the subject matter described herein;

FIG. 4 is an image of an example embodiment of configuration parameters of content data generated using the system of FIG. 1 according to the subject matter described herein;

FIG. 5 is an image of an example embodiment of content data generated using the system of FIG. 1 according to the subject matter described herein;

FIG. 6A is an image of an example embodiment of a transaction record including a bar code generated using the system of FIG. 1 according to the subject matter described herein;

FIG. 6B is an image of an example embodiment of a transaction record including a quick response (QR) code generated using the system of FIG. 1 according to the subject matter described herein;

FIG. 7 is a system block diagram illustrating one embodiment of a dispensing system configured for use in the system of FIG. 1 according to the subject matter described herein;

FIG. 8 is a system block diagram of another embodiment of a dispenser configured for use in the system of FIG. 1 according to the subject matter described herein;

FIG. 9 is a diagram illustrating a perspective view of an embodiment of the dispenser of the system of FIG. 1 configured to dispense a liquid product according to the subject matter described herein;

FIG. 10 is a perspective view of an embodiment of the dispenser of the system of FIG. 1 configured to dispense electricity according to the subject matter described herein;

FIG. 11 is a front view of an embodiment of the dispenser of the system of FIG. 1 configured to dispense a gaseous product according to the subject matter described herein; and

FIG. 12 is a block diagram of an exemplary computing system configured for use in the system of FIG. 1 according to the subject matter described herein.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape.

Existing dispensing environments lack the ability to dynamically generate and provide curated content data to users. Advertising in dispensing environments is often limited to static content data (e.g., mass-produced printed coupons) or static retail signage of a particular promotion. Digital content data can be provided to a user via a display configured in the dispensing environment, such as a display of a dispenser, a display of a retail facility, or digital billboard, or the like. Digital content data can also be provided to a user via the user’s computing device, such as content data associated with a loyalty program in which the user is a registered user or a promotion received via email or text based on membership in the loyalty program. Digital content data can also be acquired by the user scanning a displayed code (e.g., a QR code) in the dispensing environment. However, static and digital content data is often generated and provided to the user separately, outside of, or away from a point-of-sale (POS) system of the dispensing environment that the user is required to use to conduct a dispensing or purchasing transaction for goods or services available in the dispensing environment.

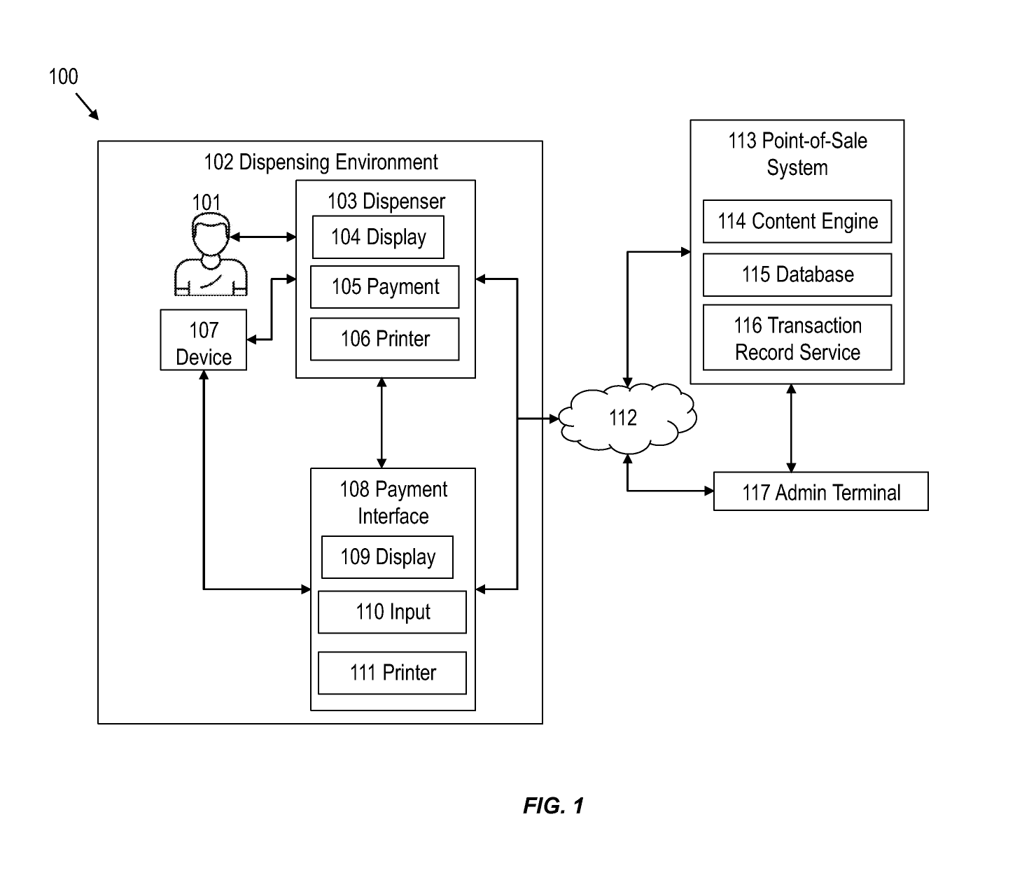

As shown in FIG. 1, a system 100 configured to determine and generate content data in a dispensing environment is provided. The system 100 can include one or more dispensers 103 configured in a dispensing environment 102. A user 101 can engage with the dispenser 103 to provide inputs to the dispenser to conduct a dispensing operation, such as dispensing a product to a vehicle within the dispensing environment 102. The dispenser 103 can include a display 104, a payment interface 105, and a printer 106. The display 104 can be configured to receive user inputs, such as inputs provided to a touchscreen display and to display relevant data associated with dispensing operations. The display 104 can also be configured to display content data and to receive inputs associated with selections of the content data. The payment interface 106 can be configured to receive inputs associated with payment instruments, such as a credit card. In some embodiments, the payment interface 106 can include a magnetic strip card reader or a near-field communication (NFC) reader configured to receive payment data configured on the payment instrument. The printer 106 can be configured to print a transaction record, such as a receipt including transaction data for the dispensed products and/or one or more goods or services acquired from the dispensing environment 102. In some embodiments, the printer 106 can be configured to print content data, such as a coupon associated with a good or service available within the dispensing environment 102.

The user 101 can be in possession of a computing device 107 that can be communicably coupled to the dispenser 103. In some embodiments, the user 101 can be a retail patron of the dispensing environment 102 and the computing device 107 can be in possession of the user 101. For example, the computing device 107 can be configured with a loyalty application associated with the dispensing environment 102 and identity data identifying the user 101 can be configured in the loyalty application. In some embodiments, the user 101 can be an attendant of the dispensing environment 102 and the computing device 107 can be configured to manage operations of the dispenser 103 and/or the dispensing environment 102.

The dispenser 103 and the computing device 107 can be communicably coupled to a payment interface 108. In some embodiments, the payment interface 108 can be configured within the dispenser 103. In some embodiments, the payment interface 108 can be configured in a retail facility of the dispensing environment 102. In other embodiments, the payment interface 108 can be a standalone payment terminal that is not configured in a retail facility of the dispensing environment 102 or the dispenser 103. The payment interface 108 can include a display 109, an input interface 110, and a printer 111. The display 109, the input interface 110, and the printer 111 can be configured similarly to the corresponding components of the dispenser 102, except where noted otherwise. In some embodiments, the payment interface 111 can include a scanner, bar code reader, or QR code reader configured to obtain data characterizing content data included in a printed or virtually printed format of the content data described herein.

The system 100 can also include a point-of-sale (POS) system 113. The POS system 113 can be communicably coupled to the dispenser 103 and the payment interface 108 via a network 112. In some embodiments, the POS system 113 can be located remotely from the dispensing environment 102. In other embodiments, the POS system 113 can be configured within the dispensing environment 102. The network 112 can include a private local area network (LAN), a wide-area network (WAN), or a public network, such as the Internet. The network 112 can be configured to exchange data between the various components of system 100 over open or proprietary communication protocols. In some embodiments, the computing device 107 can be coupled to the POS system 113 via the network 112. In some embodiments, the POS 113 can be configured to further include or provide forecourt controller functionality for controlling aspects of the dispenser 103 to dispense a product therefrom based on data received or exchanged with the payment interface 108. In this way the forecourt controller can be configured remotely from the dispensing environment 102 and the dispenser(s) 103 therein.

The POS system 113 can include a content engine 114, a database 115, and a transaction record service 116. The content engine 114 can be configured to generate and provide content data according to the subject matter described herein. In some embodiments, the content engine 114 can generate content data based on pricing data stored in the database 115. The content engine 114 can exchange data characterizing the content data with the display 104 via an HTML interface. For example, the content engine 114 can dynamically generate HTML data in a memory of the POS system 113 and/or the database 115. A web page corresponding to the HTML data that was dynamically generated in the memory and/or the database 115 of the POS system 113 can be transmitted to the display 104 via HTTP. The web page can be generated in the memory of the POS system 113 in order to minimize the need for large file repositories or static file repositories at the POS system 113 and/or at the dispenser 103.

Advantageously, the generated HTML is created on demand and is not stored or persisted in a database or in memory. In response to a web page request, the POS system 113 uses stored configuration and real-time contextual information to dynamically generate the HTML data. This dynamic generation enables the dispenser 103 to function as an interactive kiosk that extends the capabilities of the POS system 113. The dynamic generation of the HTML data can reduce latency and improve the speed of the POS system 113 to generate and provide the web page for display quickly. Because the HTML data is generated dynamically and not stored, the HTML data does not need to be maintained, synchronized, patched, updated, or the like, on the POS system 113. Output formatting can be adapted without duplicating content, which can improve the efficiency of generating and providing HTML data with respect to data payload sizes and/or network utilization. Not utilizing persistent memory avoids extra processing cycles and unnecessary writes to disk, which minimize reduce the operating burden of the processing components of the POS system 113. From a security perspective, the dynamic generation of the HTML data can reduce the need to store the HTML data in a non-transitory, computer readable medium, such as a memory of the POS system 113 or the dispenser 103, and thus reduces the likelihood that the memory could be inappropriately accessed and manipulated or exploited.

The content data determined by the content engine 114 can be provided to the dispenser 103 to be provided to the user 101 via the display 104 and/or the printer 106. In some embodiments, the content data can be provided to the user device 107. For example, the POS system 113 can exchange content data with the user device 107 via an application configured on the user device 107 and communicably coupled to the POS system 113. In this way, content data generated for provision to the dispenser 103 can also be transmitted through the application on the user device 107.

In some embodiments, sensor data, such as image data characterizing the user 101 or a vehicle associated with the user 101, can be received by the POS system 113 for use by the content engine 114 in determining and generating content data. For example, identity data can be determined from the image data and curated content data corresponding to a demographic that includes the user 101 as determined based on the identity data can be determined. In some embodiments, loyalty program data characterizing the user can be used as the identity data for use in determining curated content data. The image data can be processed by one or more machine learning algorithms or predictive models trained in a machine learning process to determine attributes or demographics of the user 101, a vehicle associated with the user 101, a season, a location, a region, or an occupancy of the dispensing environment 102. The determined attributes or demographics can be processed by the content engine to determine the content data. In some embodiments, the content data can be stored in a secure file format, such as in an encrypted file format. The content data configured in the encrypted file format can be retrieved from a memory of the POS 113 and/or the database 115.

In some embodiments, the POS system 113 can be communicably coupled to an administration terminal 117. For example, the administration terminal 117 can be operably coupled to the POS system 113 via the network 112. In some embodiments, the administration terminal 117 can be directly coupled to the POS system 113 and may not require data exchange via the network 112. The administration terminal 117 can be configured as a remote configuration point for the system 100.

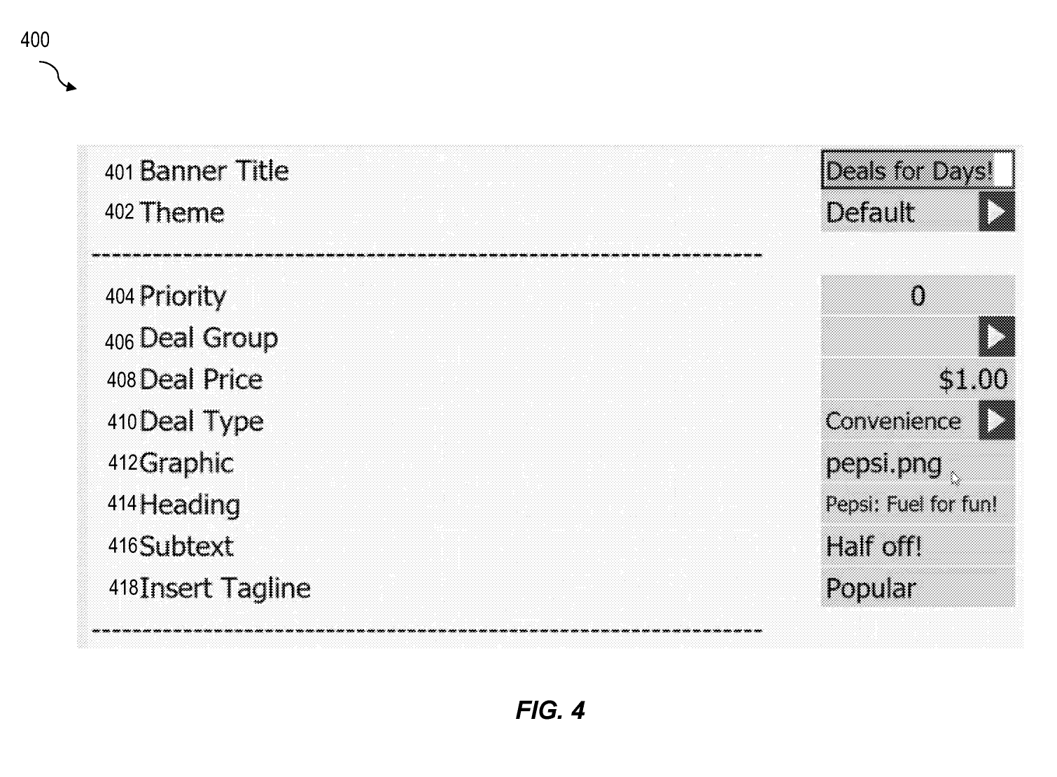

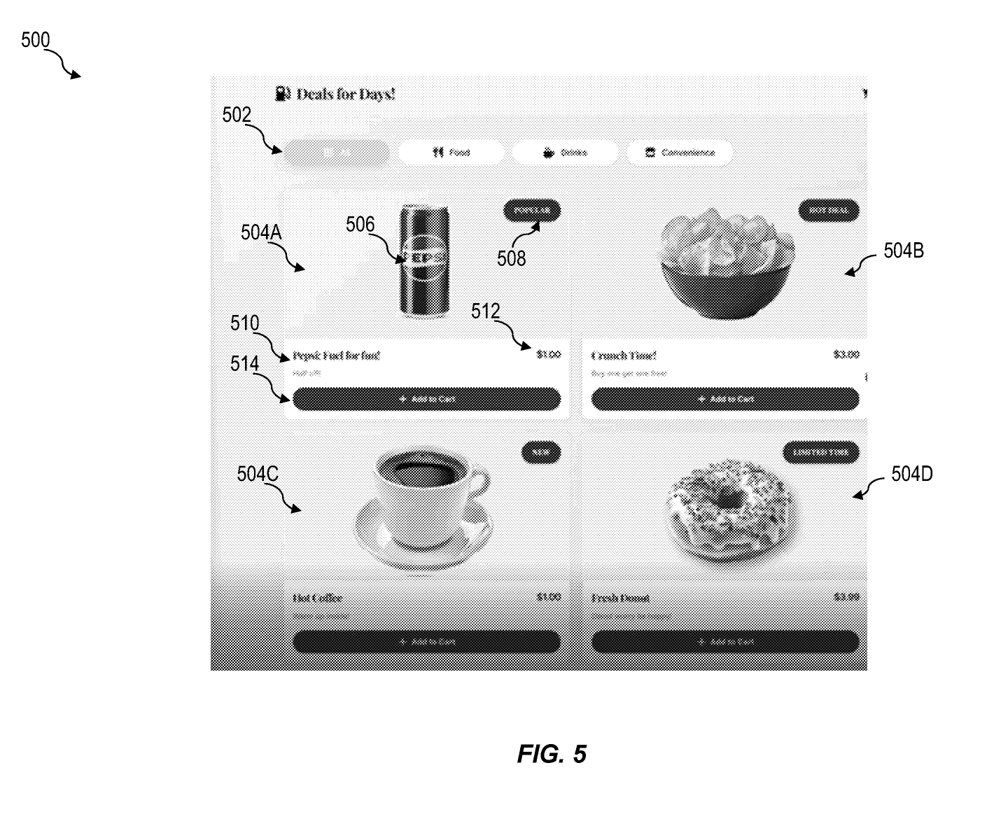

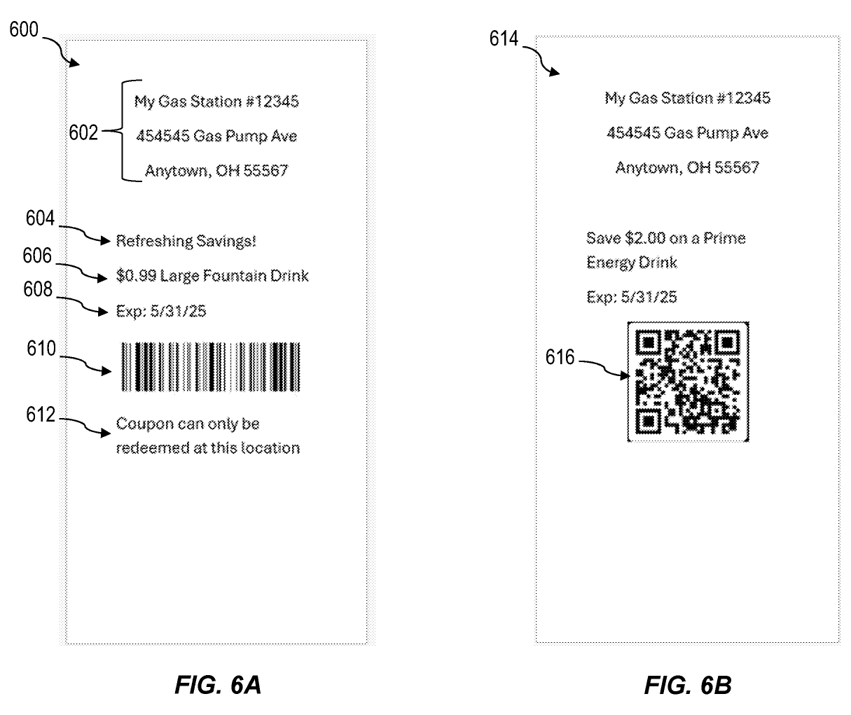

In some embodiments, the administration terminal 117 can be configured to allow an administrator or operator of the dispensing environment 102 to configure content data to be implemented on one or more of the web pages generated via the content engine 114, such as the content data shown in FIGS. 5-6B. For example, as shown in FIG. 4, an image of a user interface 400 that can be configured on the administration terminal 117 is shown. The user interface 400 can include a variety of content data parameters (CDP) 401-418 as shown on the left side of the user interface 400. Each CDP can be assigned a value from a plurality of selectable values or values that are input by a user or computing device, as shown on the right side of the user interface 400. The CDPs 401-418 can be configured to define content data that can be generated and provided on the display 104, a display of the computing device 107, the display 109, and to the printer 106. For example, CDP 401 can define a banner title. CDP 402 can define a theme of the content data, which can relate to a variety of thematic topics associated with the dispensing environment 102, the goods or services associated with the content data, or other user defined or predetermined themes. CDP 404 can define a priority of the content data, which can relate to a measure of importance of the content data compared to other content data. CDP 406 can define a promotion group that the content data belongs to. CDP 408 can define a promotion price, which can reflect a price of the goods or services associated with the content data. The promotion price can be received from the database 115, for example as a query response to a query generated by the content engine 114. CDP 410 can define a type of the content data, which can correspond to a type or a category of the goods or services associated with the content data, such as characterizing the goods or services as a food item or type, a drink item or type, a convenience item or type, a service item or type, or the like. In some embodiments, CDP 410 can define popular items, items related to a specific time of day, location, region, or demographic. CDP 412 can define a graphic associated with the content data. For example, the graphic can include image data to be included in the content data. CDPs 414-418 can define textual descriptions of the content data and can include a number of fields that can be hierarchically arranged or arranged in a user-defined pattern to convey textual data about the goods or services associated with the content data.

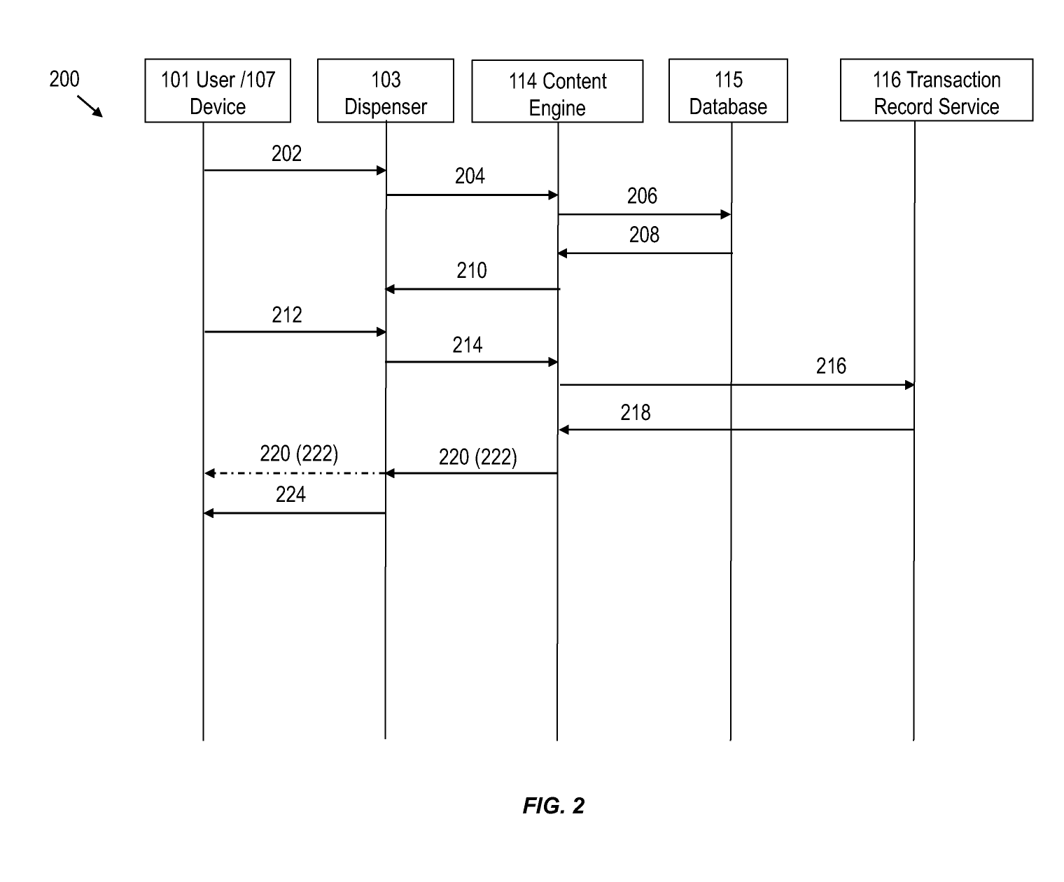

FIG. 2 is a dataflow diagram illustrating an example embodiment of data exchanged between components of the system of FIG. 1 for use in determining and generating content data according to the subject matter described herein. As shown, at 202, user 101 can initiate dispensing operations at the dispenser 103. The user 101 can initiate dispensing by lifting the dispenser nozzle from the receptacle and selecting a fuel grade, by selecting a dispensing operation from the display 104, or providing a payment instrument, such as a credit card, at the payment interface 105.

At 204, the dispenser 103 can generate a command, to the content engine 114 requesting a web page configured to include content data to be provided via the display 104 or the printer 106.

At 206, the content engine 114 can determine the web page. For example, in some embodiments, the content engine 114 can retrieve the web page from a memory thereof and can query the database 115 for content data that can be used to populate the web page. The POS system 113 can include contextual data stored in a memory thereof and/or in the database 115 that can be utilized by the content engine 114 to generate the content data to be included in the web page. For example, the POS system 113 can store a fuel type or grade, a fuel price, a payment method, a configuration of the payment interface 110, loyalty program data associated with a loyalty program profile of the user 101, a product restriction of the loyalty program, and/or an authorization amount of the loyalty program as the contextual data. The contextual data can be used to generate the web page.

At 208, a query response can be received by the content engine 114 from the database 115. The query response can include data characterizing the content data, such as data associated with the CDPs 401-418 described in relation to FIG. 4. In some embodiments, the query response can also include the contextual data. In some embodiments, the data characterizing the content data can be received in a file or data interchange format used in electronic data interchange between a server and a web application. For example, in some embodiments, the data characterizing the content data can be received in a JavaScript Object Notation (JSON) format. In some embodiments, the data characterizing the content data can be received in an extensible markup language (XML) format. In some embodiments, the file or data interchange format can be an open standards format or a proprietary format. Once received, the content engine 114 can populate the web page with the received formatted and contextual data and at 210 can serve the web page populated with the content data to the dispenser 103 for provision to the user 101 via the display 104, the computing device 107, and/or the printer 106. In some embodiments, the web page populated with the content data can be provided to the dispenser 103 at the time when fueling is initiated.

At 212, responsive to being provided with the content data via the web page, the user 101 can provide an input selecting one or more content data elements. For example, the user may select content data associated with acquiring a soft drink for a discounted price of $1. At 214, the dispenser 103 can transmit a command to the content engine 114 to provide data characterizing the content data selected by the user for generation of a transaction record.

The content engine 114, at 216, can transmit a command to the TRS 116 to generate a transaction data and to add the selected content data to a transaction record associated with the dispensing operation, such that the transaction record is further updated to include the selected content and contextual data. The TRS 116 can retain a record of any and all transactions at the dispenser 103. A record at the TRS 116 can be created at the start of a dispensing operation at the dispenser 103 and can be updated while the dispensing operation is being performed. When a user selects a good, service, or promotion data during the dispensing operation, the record at the TRS 116 can be updated. For example, if the user 101 adds an item of merchandise to their dispensing operation, the transaction record can be updated. If the user 101 prints or otherwise generates a scannable element corresponding to the user’s selection and/or a product dispensed via the dispenser 103, the transaction record can be updated to include the scannable element for redemption. In some embodiments, the scannable element can include a bar code or a quick reference (QR) code.

At 218, the TRS 116 can generate the transaction record and provide the transaction record to the content engine 114 with data confirming the addition of the selected content data to the transaction record. At 220, the content engine 114 can transmit the transaction record to the dispenser 103 (e.g., to the display 104, the printer 106, and/or the computing device 107) to acknowledge that the selected content data has been successfully added to the transaction record. In some embodiments, such as at 222, the content engine 114 can transmit a transaction record including data indicating that the selected content data was unsuccessfully added to the transaction record.

At 224, data characterizing the transaction record can be provided to the user 101 or to the computing device 107 for viewing by the user 101. In some embodiments, the data characterizing the transaction record provided at 224 can instruct the user 101 to proceed to the in-store payment interface 108, where the selected content data can be displayed on the display 109 for redemption by the user 101 or printed via the printer 111 for redemption by the user 101.

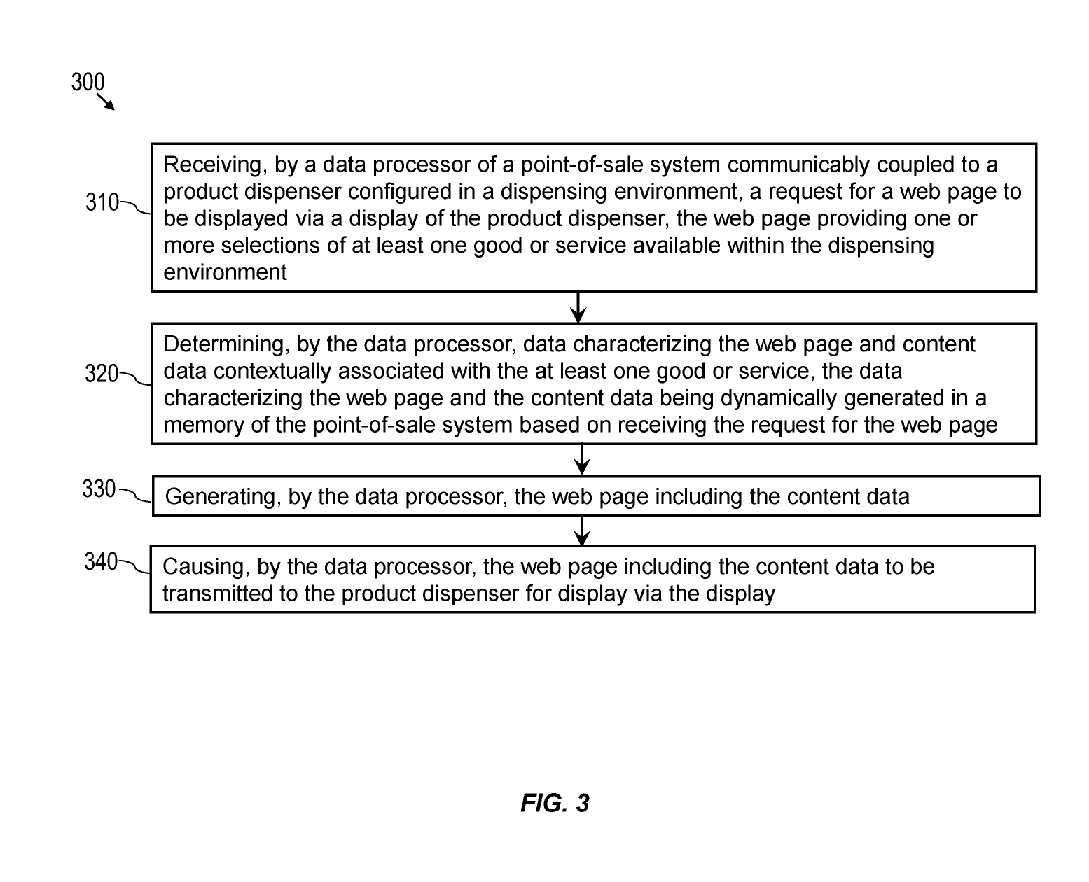

FIG. 3 is a process diagram illustrating an example embodiment of a method 300 of operations for determining and generating content data by a server, such as the server 113, according to the subject matter described herein. The generated content can be provided for display via a product dispenser. For example, at 310, the method 300 can include receiving, by a data processor of a POS system, such as the POS 113, communicably coupled to a product dispenser, such as the dispenser 103, configured in a dispensing environment, such as the dispensing environment 102, a request for a web page to be displayed via a display, such as the display 104, of the product dispenser. The web page can provide one or more selections of at least one good or service available within the dispensing environment.

At 320, the data processor can determine data characterizing the web page content and content data contextually associated with the at least one good or service. The data characterizing the web page and the content data can be dynamically generated in a memory of the POS system based on receiving the request for the web page.

At 330, the data processor can generate the web page including the content data and at 340, the data processor can cause the web page including the content data to be transmitted to the product dispenser for display via the display. In some embodiments, the web page including the content data can be provided to a computing device, such as the device 107.

Based on the above features, the system 100 can enable the contextual creation of content data to be provided in a web page displayed on the dispenser 103. The POS system 108 can be configured to receive, retrieve, and store contextual data in a memory thereof and/or the database 115 for use in dynamically generating a web page with the determined content data. The dynamically generated web page including the contextually relevant content data can be presented to the user and linked to a transaction record and the transaction record can be further updated based on the dispensing or item selection operations performed by the user 101. Based on the updated transaction record, the system 100 can generate a physical record that can be utilized to facilitate a payment transaction for the dispensed product and a good or service selected by the user and redeemable using the physical record. In some embodiments, the physical record can include the scannable element, such as the bar code or QR code.

FIG. 5 is an example embodiment of a web page 500 displayed on the display 104 of the dispenser 103 or on a display of the computing device 107 and including content data determined and generated according to the subject matter described herein. One or more aspects of the content data can be configured based on CDPs 401-418 described in relation to FIG. 4. For example, the web page 500 can include a menu of promotion types 502, which can correspond to CDP 410. A user 101 can select a promotion type 502 to filter or view contextually relevant content data characterized by the selected promotion type 502. In some embodiments, the promotion type can include “All” promotion types to provide the user 101 with a comprehensive list of all available content data.

The web page 500 can include a plurality of content data instances 504, such as instances 504A-504D. Each instance 504 of content data can include a graphic 506, which can correspond to CDP 412 and can characterize an image of the good or service associated with the content data. Instances 504 can also include a tagline 508, which can correspond to CDP 418 and can describe a marketing adjective associated with the content data. Instances 504 can also include textual descriptions 510 of the goods or services, which can correspond to CDPs 414, 416 and can characterize a description of the goods or services and a description of a value of the promotion. Instances 504 can also include a price 512, which can correspond to CDP 408 and can characterize a value of the promotion price of the good or service. Instances 504 can also include a selection indicator 514, with which the user 101 can engage to select the instance 504 and to apply the content data to a transaction record. For example, responsive to selecting indicator 514, the content data associated with the soft drink for the discounted price of $1 can be added to a cart or similar transaction record for redemption at payment interface 108.

In some embodiments, the content data can be determined and generated in a transaction record. The transaction record can include content data associated with a good or service available for sale or offered within the dispensing environment. In some embodiments, the transaction record may be associated with a good or service that is not available for sale or offered within the dispensing environment. For example, in some embodiments, the transaction record can include content data associated with a good or service available at a business that is separate from (e.g., remotely located) the dispensing environment. In some embodiments, the content data can include text or data that is not associated with a good or service offered for sale. For example, in some embodiments, the content data (and the transaction record) can include poetry, navigation directions, weather data, lottery data, or a fortune (e.g., such as a fortune provided within a fortune cookie). A wide variety of text associated with a number of use cases and applications can be envisioned.

In some embodiments, the transaction record can include a printed format, such as a printed coupon or voucher. In some embodiments, the printed content data can be printed on paper via the printer 106 configured in the dispenser 103. In some embodiments, the content data can be virtually printed, such as content data that is rendered on a display of the computing device 107 in the same or similar format as printed content data. The user 101 can bring the printed content data or the displayed content data to the payment interface 108 for redemption and application to their transaction record associated with the dispensing operation and/or one or more goods or services. FIGS. 6A-6B are exemplary embodiments of transaction records 600, 614 that can be printed physically or printed virtually with content data that can be generated on the display of the computing device 107. The transaction records 600, 614 can include a number of fields that are predetermined or can be configurable by the operator of the dispensing environment 102.

As shown in FIG. 6A, the transaction record 600 can include location data 602 characterizing a location of the dispensing environment 102. For example, the location data 602 can include an address of the dispensing environment 102, directions to the dispensing environment 102, or the like. The transaction record 600 can also include textual data 604-608 and 612 characterizing a promotion headline, a value of the promotion price, a description of the good or service associated with the printed content data, an expiration date of the printed content data, and guarantee or limitations associated with the printed content data. In some embodiments, the transaction record 600 can include a two-dimensional bar code 610 characterizing data associated with the printed content data 600. In some embodiments, as shown in FIG. 6B, the printed content data 614 can include similar fields as the transaction record 600 and can further include a QR code 616. A user 101 can present the printed content data 600, 614 at the payment interface 108 and the bard code 610 or the QR code 616 can be scanned by the payment interface 108 to redeem the data characterizing the printed content data to be applied to the user’s transaction record.

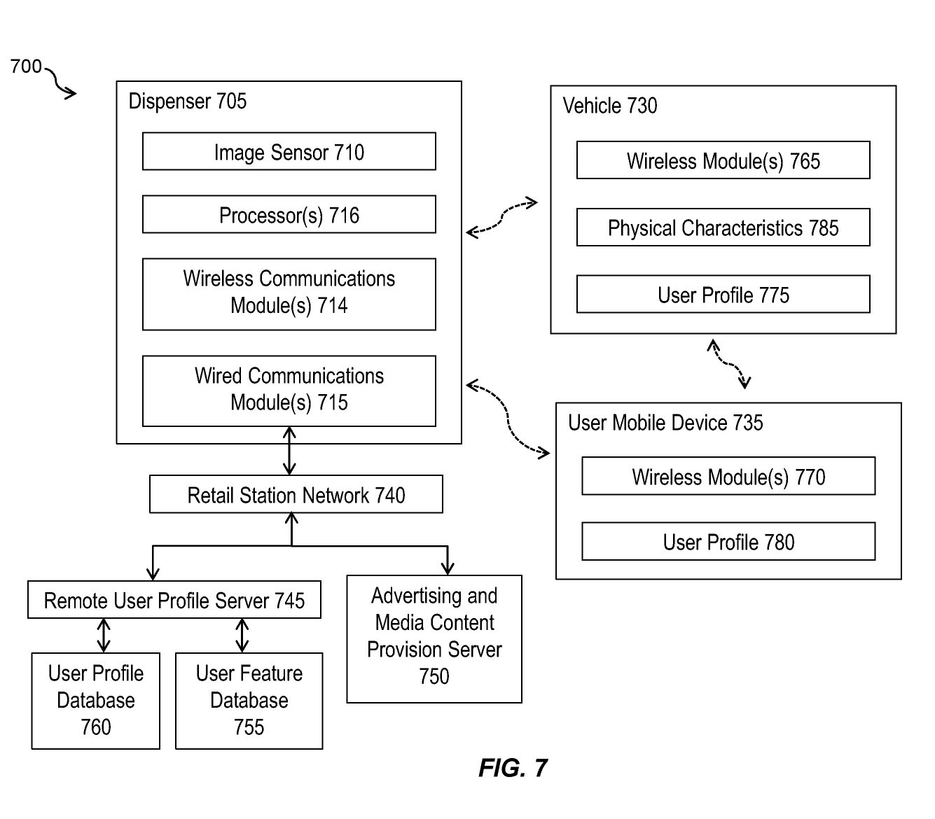

FIG. 7 is a system block diagram illustrating one embodiment of a dispensing system 700. The dispensing system 700 can correspond to the portions of the system 100 shown and described in relation to FIG. 1, such as the dispenser 103, except where noted otherwise. The dispensing system 700 can be configured within a dispensing environment, which can include a plurality of dispensers 705 arranged about a dispensing environment forecourt, a retail sales facility or operation, and/or a vehicle service or maintenance facility or operation. The dispensing system 700 includes a dispenser 705 capable of exchanging data with a dispenser user, a vehicle, and/or a computing device of the dispenser user. The dispenser 705 can perform operations that include, but are not limited to, receiving inputs related to selecting products available via the dispenser 705, performing dispensing transactions, exchanging loyalty program data with users, displaying graphical and textual content associated with goods and services available within the dispensing environment, and receiving user inputs regarding the available goods and services.

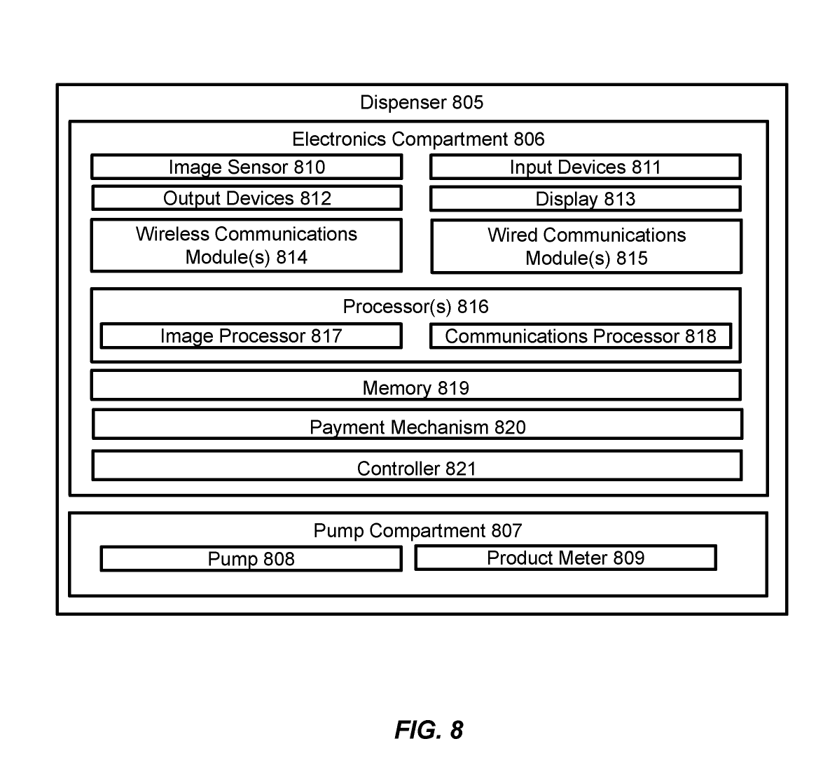

FIG. 8 illustrates an embodiment of the dispenser 705 shown in FIG. 7. As shown in FIG. 8, the dispenser 805 can include an electronics compartment 806 and a pump compartment 807. The electronics compartment 806 can contain electronics for facilitating payment for dispensed products, such as fuel, and for facilitating dispensing of the dispensed products. In some embodiments, the electronics can facilitate payment for goods and services available within the dispensing environment, including but not limited to a food item, a beverage, a parking space, a pharmacy item, groceries to be delivered, a car wash, a tire pressure check, public transit, and the like. The electronics compartment 806 can include an image sensor 810, data processor(s) 816, wireless module(s) 814, wired communications module(s) 816, input devices 811, output devices 812 and a memory 819 or similar non-transitory storage medium configured to store computer-readable and executable instructions, which when executed by the processor 816 perform operations of the dispenser 805 described herein.

The image sensor 810 can include a thermochromic camera, an infrared camera, a digital still camera, or a video camera, although other optical sensors are possible. In some embodiments, the image sensor 810 can be affixed to an exterior surface of the dispenser 805. In some embodiments, the image sensor 810 can be configured within the dispensing environment and communicably coupled to the processors 816. The input devices 811 can include an alphanumeric keypad, a numeric keypad, a microphone, or the like. The output devices 812 can include a speaker, a printer, or the like.

The display 813 can be capable of providing information to a user of the dispenser 805. The display 813 can have a variety of configurations, such as a cathode ray tube (CRT) screen, a liquid crystal display (LCD) screen, a light emitting diode (LED) screen, a touchscreen, and the like. For example, the display 813 can include a single display. Alternatively, the display 813 can include multiple displays. For example, a first display 813 can be on a front side of the dispenser 805 and a second display 813 can be on a back side of the dispenser 805. As another example, the display 813 can include two displays mounted next to each other to increase an overall display size. As yet another example, the display 813 can include first and second displays mounted next to each other on the front side of the dispenser 805 and can include third and fourth mounted next to each other on a back side of the dispenser 805.

The communications modules, such as either of the wireless communications module(s) 814 or the wired communications module(s) 815 are capable of exchanging data between the dispenser 805 and computing devices communicably coupled to the dispenser 805. For example, in some embodiments, the wireless communication module(s) 814 can be capable of communicating or exchanging data wirelessly with a remote system (e.g., a remote cloud server, a third-party payment authorization system, etc.) utilizing a variety of communication protocols, e.g., TCP/IP, etc. In some implementations, the wireless communication module(s) 814 can be capable of facilitating wireless communication over a short-range communication link. For example, the wireless communication module(s) 814 can include a transceiver configured to communicate via any of a variety of short-range wireless techniques, such as a Bluetooth protocol, a Wi-Fi protocol, near field communication (NFC), an ultra-wideband (UWB) protocol, a radio frequency identification (RFID) protocol, etc. Any of a variety of types of wireless connectivity hardware can be used for the short-range wireless connectivity, as will be appreciated by a person skilled in the art. The types of wireless connectivity that the wireless communication module(s) 814 includes can be chosen by an owner of the dispensing system 700 according to the owner’s current dispensing site setup and/or future dispensing environment plans, and the wireless communication module(s) 814 may be manufactured and/or updated accordingly.

In some embodiments, the wireless module(s) 814 can operatively connect the dispenser 805 with a vehicle, such as the vehicle 730 shown in FIG. 7 and a computing device, such as the computing device 735 shown in FIG. 7. The wireless module 814 can include, e.g., a transceiver communicating via Bluetooth protocol, cellular protocol, WIFI protocol, near field communication (NFC), and/or a radio frequency identification (RFID) protocol. The wired communications module 815 operatively connects the dispenser 805 with a remote server, such as the remote user profile server 745 and/or an advertising and media content provision server 750 via a retail station network 740 shown in FIG. 7. The retail station network 740 can connect multiple dispensers 705 together over a local area network (LAN).

In some embodiments, the wired communication module(s) 815 can be configured to communicate or exchange data over a wired connection in addition to or instead of over a wireless connection. A wired connection can be used, for example, for a local communication link between the dispenser 805 and a local computing system external to the dispenser 805 (e.g., a forecourt controller, an in-store a point of sale (POS) device, etc.). A wired connection may provide more security and/or stability than a wireless connection and/or may allow a legacy dispenser 805 configured to communicate only via one or more wired connections to implement dynamic management of content provided via the display 813. Wired communication can occur via any of a variety of wired communication protocols, e.g., TCP/IP, etc., as will be appreciated by a person skilled in the art. Some dispensers 805 are manufactured with two-wire connectivity, and the wired communication can accordingly be via two wires, such as via a controller area network bus (CAN Bus) two wire connection, an RS 485 two wire connection, a current loop connection, or other type of two wire connection. Some dispensers 805 are additionally or alternatively manufactured with cable connectivity and can accordingly be configured to provide wired communication via cable connection, such as an Ethernet cable or other network cable. Older dispensers 805 typically have two-wire connectivity capabilities while newer dispensers 805 typically have Ethernet connectivity capabilities instead.

The processor(s) 816 can include one or more processors forming part of at least one computing system. In one embodiment, the processor(s) 816 include at least an image processor 817 and a communications processor 818 as shown in FIG. 8. An image processor can receive one or more images from the image sensor 810 and determine identity information of a customer using the images. Identity information can include, for example, facial feature of a customer, a vehicle feature, a license plate number, a non-facial body feature, and the like. The image processor 817 can receive an image from image sensor 810, for example, when the dispenser 805 detects that a customer or user is proximate to the dispenser 805 and/or is in the field of view of the image sensor 810. The image can be of the customer (e.g., the image can contain a visual representation of the customer) and/or the customer’s vehicle, for example. The image processor 817 is capable of performing operations, including but not limited to, receiving image data, and identifying physical characteristics of the user or a vehicle to determine regions within the image data in which the customer’s face, body, and vehicle reside.

Using these regions, one or more image features related to the customer’s face, body, and vehicle. For example, a facial feature can include skin texture; relative position, size, and/or shape of the eyes, nose, cheekbones, and jaw; and the like. Body features can include height, weight, hair color, body shape, and the like. Vehicle features can include shape, color, license plate number, manufacturer/make/model decal, and the like.

In at least some implementations, the image processor 817 is capable of classifying aspects of the image data as a vehicle, a non-facial body part, and/or a safety object or event. For example, the image processor 817 can classify (or determine) characteristics of the customer’s vehicle based on the vehicle features. These characteristics can include, for example, license plate number, vehicle make, required grade and/or type of fuel for the vehicle, and vehicle model.

The image processor 817 is also capable of classifying (or determining) characteristics of the customer that do not directly derive the customer’s identity based on the non-facial body features. For example, the image processor 817 is capable of determining a customer’s height, weight age, gender, disability status (e.g., in a wheelchair or not in a wheelchair, etc.), and the like.

The image processor 817 is further capable of classifying (or determining) behavior of the customer that relates to safety and is based on an extracted feature present within the image data. For example, the image processor 817 can determine whether the customer is smoking, whether the customer is grounded prior to dispensing products or fuel, whether the vehicle engine is running during fueling, and whether the customer is about to “drive-off” (which can include leaving the fuel retailer without paying for dispensed products or fuel). Other determinations can include environmental, mechanical, electrical, and/or logical instruction conditions, such as, for example, temperature, pressure, humidity, fuel leaks, open panels, dispenser intrusion, power irregularities, watchdog timer expiration, and software exceptions.

Based on these classifications, the image processor 817 is capable of generating an alarm. The alarm can include a warning (e.g., signal, audio, light, and the like) to an attendant of the dispensing environment, such as at a site of the dispenser 805. The warning can include an audible sound emanating from the dispenser 805, a visual or graphical warning on the display 813 of the dispenser 805 indicating that products cannot be dispensed until the detected problem is corrected, and the like. Generating the alarm can include causing a corrective action to be performed, for example, restarting the dispenser 805 (e.g., in the event that a mechanical, electrical, and/or logical problem with the dispenser 805 is detected by the image processor 817), shutting down the dispenser 805 (e.g., in the event that an unsafe condition is detected by the image processor 817, such as the customer smoking before or during fueling, the customer not being grounded prior to dispensing fuel or products, the vehicle engine running during fueling, or a mechanical, electrical, and/or logical problem with the dispenser 805 being detected that cannot be fixed without manual intervention), downloading instructions for the dispenser 805 (e.g., to correct a mechanical, electrical, and/or logical problem with the dispenser 805), and/or generating notifications for other components at the fueling facility that includes the dispenser 805 (e.g., in the event an unsafe condition is detected by the image processor 817 that may affect safe functioning one or more other dispensers 805 within the dispensing environment).

In at least some implementations, image data including the facial features of a user or customer can be conveyed via the dispenser’s communications module(s), such as the wireless module(s) 814 and/or the wired communications module(s) 815 to a remote server, such as the remoter user profile server 745 shown in FIG. 7 and described more fully below.

Referring again to FIG. 7, the dispenser 705 can transmit image data including facial features of a user or customer to a remote user profile server 745 in order to match the customer with a known customer identity. The remote user profile server 745 can receive the facial features and access a user feature database 755 (which may include one or more databases) containing known customer features. The database 755 can contain features of customers that have previously visited the dispenser 705 or that have previously enrolled in a customer rewards program associated with the facility providing the dispenser 705 and provided an image of their face in association with the program. The database 755 can also associate unique identities (e.g., names or unique identifiers) with known facial features, e.g., in a table. The remote user profile server 745 can compare the received facial features with the features in the database 755 to find a match. If and once a match is found, the remote user profile server 745 can use the associated customer identifier to query a user profile database 760. The user profile database 760 can contain user profiles for each known customer in the feature database 755 (which may include one or more databases). User profiles can include preferences related to dispensed products (e.g., a preferred product grade, a product type, a payment method, a loyalty rewards identifier, whether to apply loyalty rewards to a present purchase, whether to purchase a car wash, and the like). The user profile and/or identity can be transmitted from the remote user profile server 745 to the dispenser 705.

The user profile and/or identity may be received by the communications processor 818 and can be stored in the memory 819. The user profile can be used by the communications processor 818 to provide a customized product dispensing experience. For example, the user profile can be accessed and the dispenser 805 can be configured with the customer’s preferences. This can include rendering, on the display 813, a preference selection screen populated with the customer’s dispensing preferences as specified in the user profile. In at least some implementations, the dispenser 805 can render a personalized greeting on the display 813.

In at least some implementations, identity information can be received by the communications processor 818. The identity information can include a name or unique identifier of the customer. This identity information can be used by the communications processor 818 to acquire the user profile from the remote user profile server 745. In at least some implementations the identity information can include, for example, facial features of the customer, vehicle features, license plate number, non-facial body features, and the like.

In at least some implementations, the user identity can be provided to an advertising and media content provision server 750, which can provide customized or targeted advertisements and content to the dispenser 705 for provision to the customer during dispensing of products, e.g., by displaying the advertisements and content on the display 813. For example, once the user identity is determined, advertisements can be dynamically determined and provided.

The advertisements can be pre-specified by remote merchants. Remote merchants can be any appropriate sellers of goods and/or services. For example, a merchant may sell durable goods (e.g., vehicle parts, toys, etc.), perishable goods (e.g., food, drink, etc.), intangible goods (e.g., software, digital media, etc.), or services (e.g., oil changes, car washes, etc.). Remote merchants can include any appropriate computer systems (e.g., servers and databases) for allowing them to send data regarding their goods and/or services over a communication network to fuel dispensers. Remote merchants can operate proactively, interactively, and/or or passively with fuel dispensers to market and/or sell their goods and/or services. For example, the remote merchants can download merchandising content (advertisements and pricing data) to the dispensers 705 at designated times or events, or the remote merchants can download merchandising content to the dispensers 705 upon request. In at least some implementations, the remote merchants can maintain a Web-based portal through which the dispensers 705 can download the content. As discussed herein, remote merchants are remote in the sense that they are not located at the dispensing environment that includes the dispensers 705 to which the remote merchants provide advertisements and/or other content. Thus, the remote merchants can be located in the neighborhood of the dispensing environment. One or more the merchants, of course, could be located at greater distances (e.g., across the state or country) from the dispensing environment.

Dynamic advertisements can include a listing of goods and/or services, along with descriptions and pricing information. The advertisements can include text, graphics, audio, and/or video for presentation at the dispenser 705.

Using the user profile and/or user identity information, the dispensers 705 can determine when to present the above-described merchant-provided data. For example, a dispenser 705 may present the data (e.g., on a display thereof) at certain points of a product dispensing session (e.g., while a product or a fuel is being dispensed or after dispensing the product or fuel is complete). The dispenser 705 can then determine whether the customer indicates interest in the merchant data (e.g., by detecting user input regarding the presented data). If the dispenser 705 detects user interest in the merchant-provided data, the dispenser 705 can present additional information regarding the goods and/or services and determine whether the customer desires to order a good and/or service. Additional information regarding goods or services can include textual descriptions, images, audio, and/or video.

If a customer desires to order a good and/or service, the dispenser 705 can acquire order data (e.g., quantity, price, and delivery information) or the order data can be included or inferred from the customer’s user profile. The dispenser 705 can also acquire or infer payment data from the user profile. The dispenser 705 can also evaluate whether the payment data is sufficiently complete. If the payment data is acceptable, the dispenser 705 can then generate a message for the appropriate remote merchant regarding the order and payment information and generate a receipt for the customer. The appropriate merchant can then make arrangement for delivery of the goods and/or service.

To facilitate customer interaction in at least some embodiments, the user profile can include customer-related data. The customer-related data can, for example, be associated with a customer identifier (e.g., a credit card number, a personal identification number (PIN), a telephone number, a radio frequency identifier (RFID) number, or a loyalty program number). The customer-related data can be information regarding a product dispensing session (e.g., a type of product or fuel, a display language for the dispenser display, audio settings for the dispenser, or payment preferences (e.g., certain credit card, certain debit card, cash to be paid at a staffed payment terminal, etc.)), data regarding services at the dispensing environment (e.g., car wash, air pump, or water hose), or data regarding the customer (e.g., address and preferred payment types). In at least some implementations, the customer-related data can be used to identify other information that may be of interest to the customer. For example, particular types of merchandise (e.g., drinks, newspapers, or food) or offers (e.g., coupons or advertising) can be presented to the customer based on customer-related data. This presentation can, for example, be based on the customer’s past purchasing habits in a fueling facility store. The customer-related data can be acquired from the user profile and/or from a remote server using the customer identity.

In at least some implementations, the dispenser 705 can receive the user profile directly from a vehicle 730 (e.g., the customer’s vehicle) and/or the mobile device 735. Each of the vehicle 730 and the mobile device 735 can include wireless module(s) 765, 770 (respectively) in communication with one another and with the wireless module(s) 714 of the dispenser 705. Communications between the vehicle 730 and the dispenser 705 can use an on-board diagnostics (OBD) mechanism of the vehicle 730, e.g., OBDII technology in which the vehicle 730 includes an OBDII port (cars manufactured after 1996 have an OBDII port). A copy of the user profile 780 can be contained on the customer’s vehicle (for example, a smart vehicle having at least one data processor forming part of at least one computing system with the user profile stored in a memory of the at least one computing system) and/or a copy of the user profile 775 can be contained on the customer’s mobile device 735 (e.g., in a memory thereof). When the dispenser 705 detects that the customer is proximate thereto (for example, via the image sensor 710 and/or the wireless module(s) 714), the wireless module(s) 714 can initiate a communication session with the vehicle 730 and/or the mobile device 735 and retrieve the customer’s user profile. Once the user profile is received directly from the vehicle 730 or the mobile device 735, the customized dispensing experience can be provided as described above.

Returning to FIG. 8, the electronics compartment 806 can also include a payment mechanism 820 (e.g., a card reader, a Near Field Communication (NFC) module, etc.) configured to facilitate payment for dispensed products, such as fuel, (or other goods and services). The payment mechanism 820 can be configured to receive inputs such as, e.g., user identification information and/or payment information, and deliver the information to the controller 821. For example, the payment mechanism 820 can include a barcode and/or QR code scanner, and/or an NFC contactless card reader for receiving payment information, user identification information, vehicle information, and/or loyalty program information. In some embodiments, the payment mechanism 820 can be communicably coupled to a point-of-sale (POS) device or component. In some embodiments, the payment mechanism can include a pin-pad device, such as an SPM device as described herein.

The electronics compartment 806 can also include a controller 821 configured to receive instructions from the processor(s) 816 and generate one or more control signals controlling operations of components of the dispenser 805 in accordance with the operations described herein. In some embodiments, the controller 821 can include a data processor and a memory storing computer-readable and executable instructions, forming part of at least one computing system within the electronics compartment 806. In some embodiments, controller 821 can be operably coupled to components of the electronics compartment 806, such as the display 813, the image sensor 810, the wireless communication module(s) 814, the wired communication module(s) 815, the processor(s) 816, the memory 819, and the payment mechanism 820, and the controller 821 can be configured to control operations thereof. In some embodiments, the controller 821 can be configured as a fuel controller and can be operatively coupled to components of the pump compartment 807, such as the pump 808 or the product meter 809. The fuel controller 821 can generate control signals controlling operations of the pump 808 or the product meter 809.

The pump compartment 807 houses a pump 808 configured to provide a liquid dispensed product, such as fuel, from a storage tank or other reservoir. The pump compartment 807 can also include one or more product meters 809 that can be configured to monitor flow of dispensed products, flow of additives added to the dispensed product, and/or flow of other components of the dispensed product fuel. The pump compartment 807 can also include other components to facilitate product dispensing and mixing, such as motors and valves, a strainer/filtering system, a vapor recovery system, and the like. The pump compartment 807 is isolated from the electronics compartment 806 within the dispenser 805 to facilitate safety, security, and/or maintenance, as will be appreciated by a person skilled in the art. Dispensed products do not flow or are not conveyed from the pump compartment 807 to the electronics compartment 806 and instead the dispensed products, such as fuel, flow or otherwise are conveyed through the pump compartment 807 to a dispensing device of the dispenser 805, such as a hose and a nozzle at an end of the hose. The dispenser 805 can include any number of hoses and associated nozzles.

A person skilled in the art will appreciate that the dispensers 705, 805 can have various other configurations. Various exemplary implementations of dispensers and methods of provisioning software thereto are described further in, for example, U.S. Pat. No. 10,214,411 entitled “Fuel Dispenser Communication” issued Feb. 26, 2019; U.S. Pat. No. 10,269,082 entitled “Intelligent Fuel Dispensers” issued Apr. 23, 2019; U.S. Pat. No. 10,577,237 entitled “Methods And Devices For Fuel Dispenser Electronic Communication” issued March 3, 2020; U.S. Pat. No. 10,726,508 entitled “Intelligent Fuel Dispensers” issued Jul. 28, 2020; U.S. Pat. No. 11,276,051 entitled “Systems And Methods For Convenient And Secure Mobile Transactions” issued Mar. 15, 2022; U.S. Pat. No. 11,429,945 entitled “Outdoor Payment Terminals” issued Aug. 30, 2022; U.S. Pat. No. 11,443,582 entitled “Virtual Payment System and Method for Dispensing Fuel” issued Sep. 13, 2022; U.S. Pat. App. Pub. No. 2023/0196360 entitled “Conducting Fuel Dispensing Transactions” published Jun. 22, 2023, and U.S. Pat. App. Pub. No. 2023/0103400 entitled “Intelligent Electronic Fueling Station Component Provisioning” published Apr. 6, 2023, each of which are hereby incorporated by reference in their entireties.

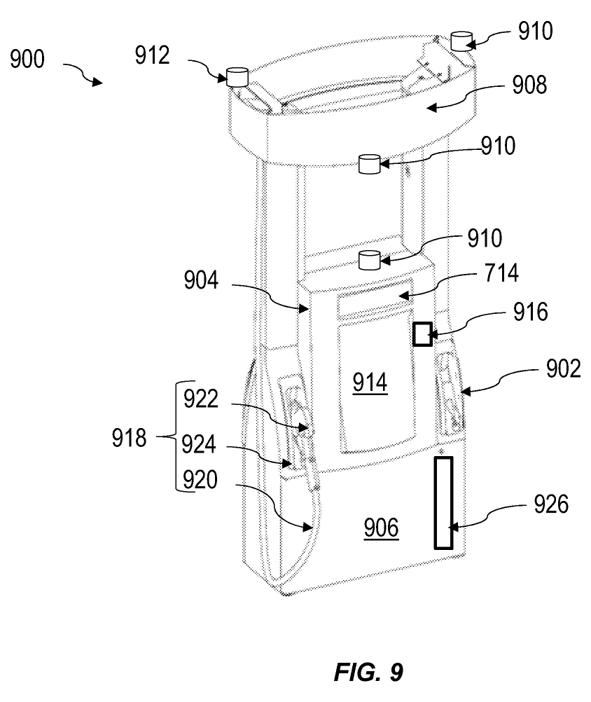

FIG. 9 illustrates a perspective view of one embodiment of a dispenser 900. The dispenser 900 is an embodiment of dispenser 103 of FIG. 1 and dispensers 705, 808 of FIGS. 7-8. The dispenser 700 can be configured to dispense liquid products (e.g., petroleum fuel). For example, in some embodiments, the dispenser 900 can be configured to dispense liquid products such as gasoline, diesel fuel, ethanol-based fuels, biofuels, diesel exhaust fluid (DEF), fuel additives (e.g., acetone, ether, nitrous oxide, nitromethane, butyl rubber, ferox, oxyhydrogen), water and the like.

As shown in FIG. 9, the dispenser 900 can include a dispenser body 902 in which the electronics compartment 904 and the pump compartment 906 are configured. The dispenser 900 can also include a dispenser awning 908 coupled to the dispenser body 902. In some embodiments, the dispenser body 902 can include the dispenser awning 908. In some embodiments, the dispenser body 902 can exclude the dispenser awning 908. The dispenser awning 908 can include at least one image sensor 910 and at least one wireless transmission module 912 configured thereon. In some embodiments, the dispenser body 902 can, additionally or alternatively, include an image sensor 910. As further shown, the dispenser body 902 can include a display 914, a payment mechanism 916, and a dispensing assembly 918.

The dispenser body 902 can include an electronics compartment 904 and a pump compartment 906. The pump compartment 906 is isolated from the electronics compartment 904 within the dispenser 900 to facilitate safety, security, and/or maintenance, as will be appreciated by a person skilled in the art. Dispensed products or fuel is thus not allowed to flow from the pump compartment 906 to the electronics compartment 904 and instead flows from the pump compartment 906 to the dispensing assembly 918. The dispensing assembly 918 can include a hose 920 coupled to a nozzle 922 for dispensing the liquid product. As will be appreciated by a person skilled in the art, the nozzle 922 can be configured to dispense the liquid product from the dispenser 900. The dispensing assembly 918 can also include a nozzle receptacle 924 configured to store the nozzle 922 when not in use. In some embodiments, the dispenser 900 can include 1, 2, 3, 4, 5, or 6 dispensing assemblies 918. In some embodiments, one or more first dispensing assemblies 918 can be provided on a first side of the dispenser 900 and one or more second dispensing assemblies 918 can be provided on a second side of the dispenser 900 that is opposite the first side of the dispenser 900.

In some embodiments, the dispenser 900 can be configured to dispense diesel exhaust fluid (DEF) and can include a heater 926 within the pump compartment 906 of the dispenser body 902. The heater 926 can be configured to heat the DEF and portions of the pump compartment 906 and/or dispensing assemblies 918. Heating components of the dispenser 900 can be advantageous in climates where freezing temperatures are a concern.

In some implementations, the dispensers described herein can be configured to other types of dispensed products, in addition to or instead of a liquid dispensed product. For example, the dispenser can be configured to dispense products in a gaseous format, such as hydrogen, compressed natural gas (CNG), liquified natural gas (LNG), electricity, or the like. It will be understood that the dispensing environments, dispensing systems, and the dispensers described herein are not limited to dispensing products in liquid format and that the dispensing environments, dispensing systems, and the dispensers described herein can, additionally or alternatively, be configured to dispense products in non-liquid product formats, such as a vapor, a gas, or electricity. For example, in some implementations, the dispenser 900 can be a hydrogen dispenser. As another example, in some implementations, the dispenser 900 can be a compressed natural gas dispenser. As yet another example, in some implementations, the dispenser 900 can be an electrical fuel dispenser configured to dispense electricity.

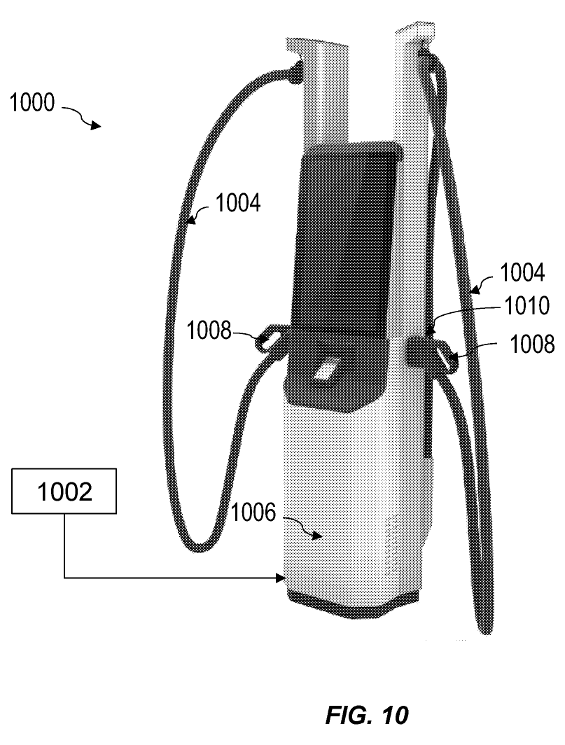

The dispenser 1000 of FIG. 10 is another embodiment of the dispenser 103 of FIG. 1, the dispenser 705, 805 of FIGS. 7-8, and the dispenser 900 of FIG. 9, except where noted otherwise. The dispenser 1000 can be configured to dispense electricity. For example, the dispenser 1000 can be configured as an electric vehicle charger. The dispenser 1000 can be operatively coupled to a power supply 1002, such as a local or regional power grid, a battery-back up power supply, a retail sales facility, or a vehicle service facility located in proximity of the dispenser 1000.

The dispenser 1000 can include a charging cable 1004 coupled to a dispenser body 1006 of the dispenser 1000. In some embodiments, the dispenser 1000 can include multiple charging cables 1004 as shown in FIG. 10 and is not limited to a configuration having a single charging cable 1004. The charging cable 1004 can be configured to deliver electricity to a charging connector 1008. The charging connector 1008 can be configured to couple to a charging port of a vehicle and to deliver the electricity provided by the dispenser 1000, via the charging cable 1004, to the vehicle when the charging connector 1008 is coupled to the vehicle charging port. When not in use, the charging connector 1008 is configured to be stored in a charger receptacle 1010 formed on the dispenser body 1006.

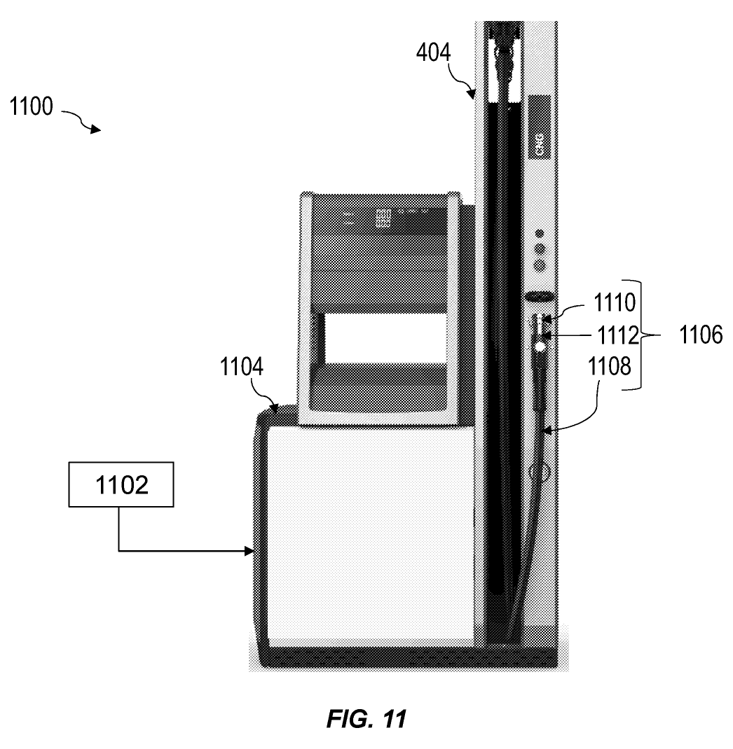

The dispenser 1100 shown in FIG. 11 is another embodiment of the dispenser 103 of FIG. 1, the dispensers 705, 805 of FIGS. 7-8, the dispenser 900 of FIG. 9, and the dispenser 1000 of FIG. 10, except where noted otherwise. The dispenser 1100 can be configured to dispense gaseous products such as compressed natural gas (CNG). In some embodiments, the dispenser 1100 can alternatively be configured to dispense liquified petroleum gas (LPG), hydrogen, and liquified natural gas (LNG). For example, the dispenser 1100 can be operatively coupled to a gas supply 1102 of CNG or other gaseous product, such as a local or regional pipeline, a stored gas supply located within the dispensing environment with the dispenser 1100, or a mobile tube trailer in proximity of the dispenser 1100.

The dispenser 1100 can also include one or more dispensing assemblies 1106 configured within the dispenser body 1104. The dispensing assembly 1106 can include a hose 1108 coupled to a nozzle 1110 for dispensing the gaseous CNG product. As will be appreciated by a person skilled in the art, the nozzle 1110 can be configured to dispense the CNG product from the dispenser 1100. The dispensing assembly 1106 can also include a nozzle receptacle 1112 configured to store the nozzle 1110 when not in use. In some embodiments, the dispenser 1100 can include 1, 2, 3, 4, 5, or 6 dispensing assemblies 1106. In some embodiments, one or more first dispensing assemblies 1106 can be provided on a first side of the dispenser 1100 and one or more second dispensing assemblies 1106 can be provided on a second side of the dispenser 1100 that is opposite the first side of the dispenser 1100.

In some embodiments, the dispensers described herein can be configured to dispense multiple product types. For example, a first portion of a dispenser including a first dispensing assembly can be configured to dispense a liquid product, such as petroleum or DEF, and a second portion of the same dispenser can include a second dispensing assembly configured to dispense a non-liquid product, such as electricity or a gaseous product, such as CNG, LNG, LPG, or Hydrogen. A variety of combinations of dispensing portions and assemblies necessary to dispense multiple, different dispensed products can be envisioned within a single dispenser body of a dispenser as described herein.

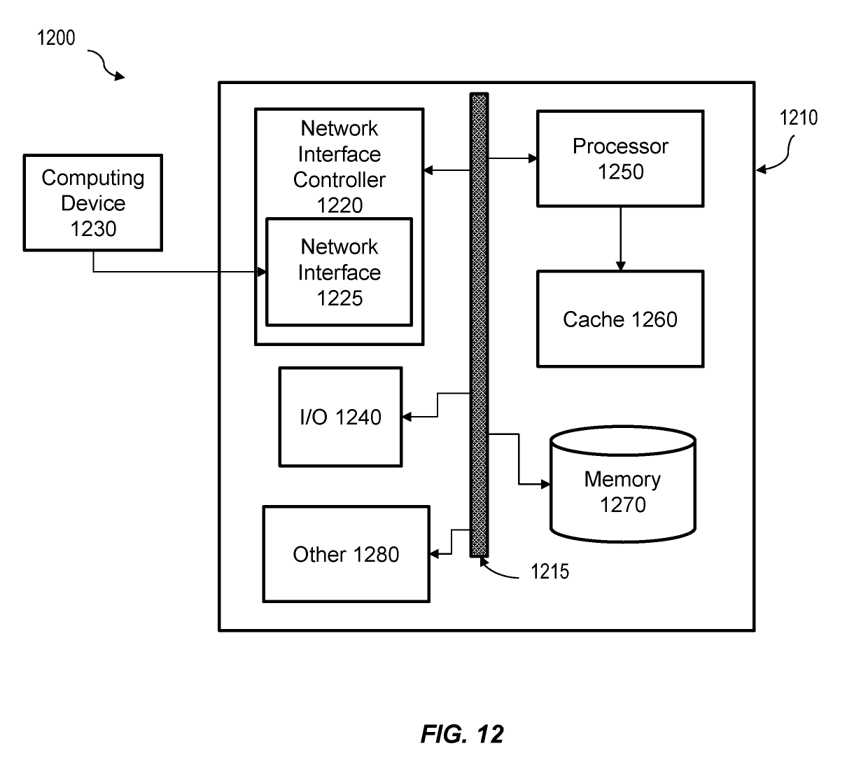

FIG. 12 is a block diagram 1200 of a computing system 1210 suitable for use in implementing the computerized components described herein. For example, one or more of the dispenser 103, the device 107, the payment interface 108, the POS system 113, and the administration terminal 117 can be or can include computing components that can be configured according to the foregoing description of the computing system 1210. In broad overview, the computing system 1210 includes at least one processor 1250 for performing actions in accordance with instructions, and one or more memory devices 1260 and/or 1270 for storing instructions and data. The illustrated example computing system 1210 includes one or more processors 1250 in communication, via a bus 1215, with memory 1270 and with at least one network interface controller 1220 with a network interface 1225 for connecting to external devices 1230, e.g., a computing device. The one or more processors 1250 are also in communication, via the bus 1215, with each other and with any I/O devices at one or more I/O interfaces 1240, and any other devices 1280. The processor 1250 illustrated incorporates, or is directly connected to, cache memory 1260. Generally, a processor will execute instructions received from memory. In some embodiments, the computing system 1210 can be configured within a cloud computing environment, a virtual or containerized computing environment, and/or a web-based microservices environment.

In more detail, the processor 1250 can be any logic circuitry that processes instructions, e.g., instructions fetched from the memory 1270 or cache 1260. In many embodiments, the processor 1250 is an embedded processor, a microprocessor unit or special purpose processor. The computing system 1210 can be based on any processor, e.g., suitable digital signal processor (DSP), or set of processors, capable of operating as described herein. In some embodiments, the processor 1250 can be a single core or multi-core processor. In some embodiments, the processor 1250 can be composed of multiple processors.

The memory 1270 can be any device suitable for storing computer readable data. The memory 1270 can be a device with fixed storage or a device for reading removable storage media. Examples include all forms of non-volatile memory, media and memory devices, semiconductor memory devices (e.g., EPROM, EEPROM, SDRAM, flash memory devices, and all types of solid-state memory), magnetic disks, and magneto optical disks. A computing device 1210 can have any number of memory devices 1270.

The cache memory 1260 is generally a form of high-speed computer memory placed in close proximity to the processor 1250 for fast read/write times. In some implementations, the cache memory 1260 is part of, or on the same chip as, the processor 1250.

The network interface controller 1220 manages data exchanges via the network interface 1225. The network interface controller 1220 handles the physical, media access control, and data link layers of the Open Systems Interconnect (OSI) model for network communication. In some implementations, some of the network interface controller’s tasks are handled by the processor 1250. In some implementations, the network interface controller 1220 is part of the processor 1250. In some implementations, a computing device 1210 has multiple network interface controllers 1220. In some implementations, the network interface 1225 is a connection point for a physical network link, e.g., an RJ 45 connector. In some implementations, the network interface controller 1220 supports wireless network connections and an interface port 1225 is a wireless Bluetooth transceiver. Generally, a computing device 1210 exchanges data with other network devices 1230, such as computing device 1230, via physical or wireless links to a network interface 1225. In some implementations, the network interface controller 1220 implements a network protocol such as LTE, TCP/IP Ethernet, IEEE 802.11, IEEE 802.16, Bluetooth, or the like.

The other computing devices 1230 are connected to the computing device 1210 via a network interface port 1225. The other computing device 1230 can be a peer computing device, a network device, a server, or any other computing device with network functionality. In some embodiments, the computing device 1230 can be a network device such as a hub, a bridge, a switch, or a router, connecting the computing device 1210 to a data network such as the Internet.

In some uses, the I/O interface 1240 supports an input device and/or an output device (not shown). In some uses, the input device and the output device are integrated into the same hardware, e.g., as in a touch screen. In some uses, such as in a server context, there is no I/O interface 1240 or the I/O interface 1240 is not used. In some uses, additional other components 1280 are in communication with the computer system 1210, e.g., external devices connected via a universal serial bus (USB).

The other devices 1280 can include an I/O interface 1240, external serial device ports, and any additional co-processors. For example, a computing system 1210 can include an interface (e.g., a universal serial bus (USB) interface, or the like) for connecting input devices (e.g., a keyboard, microphone, mouse, or other pointing device), output devices (e.g., video display, speaker, refreshable Braille terminal, or printer), or additional memory devices (e.g., portable flash drive or external media drive). In some implementations an I/O device is incorporated into the computing system 1210, e.g., a touch screen on a tablet device. In some implementations, a computing device 1210 includes an additional device 1280 such as a co-processor, e.g., a math co-processor that can assist the processor 1250 with high precision or complex calculations.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a standalone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

What is claimed is:

1. A method, comprising:
receiving, by a data processor of a point-of-sale system communicably coupled to a product dispenser configured in a dispensing environment, a request for a web page to be displayed via a display of the product dispenser, the web page providing one or more selections of at least one good or service available within the dispensing environment;
determining, by the data processor, data characterizing the web page and content data contextually associated with the at least one good or service, the data characterizing the web page and the content data being dynamically generated in a memory of the point-of-sale system based on receiving the request for the web page;
generating, by the data processor, the web page including the content data; and
causing, by the data processor, the web page including the content data to be transmitted to the product dispenser for display via the display.

2. The method of claim 1, wherein responsive to the product dispenser receiving a selection of the at least one good or service via the displayed web page and transmitting the selection to the point-of-sale system, the data processor is further configured to determine a transaction record including transaction data associated with the selection and transmit the transaction record to the product dispenser for display via the display.

3. The method of claim 2, wherein the transaction record further comprises transaction data associated with a dispensing operation performed at the product dispenser when the request for the web page is received by the data processor of the point-of-sale system.

4. The method of claim 3, wherein the transaction record further comprises an optically scannable element associated with the at least one good or service and/or the dispensing operation, the optically scannable element including one of bar code and a quick response code.

5. The method of claim 4, wherein the point-of-sale system is configured to process the optically scannable element for redemption of the at least one good or service in the dispensing environment.

6. The method of claim 1, wherein the content data is formatted in one of a JavaScript object notation format or an extensible markup language format.

7. The method of claim 1, wherein the product dispenser further comprises an image sensor configured to acquire image data characterizing one of a user of product dispenser and a vehicle positioned at the product dispenser and a communication interface configured to transmit the image data to the data processor, which once received is further configured determine the content data based on the received image data.

8. The method of claim 1, wherein the product dispenser is configured to dispense at least one of electricity, petroleum fuel, diesel exhaust fluid, compressed natural gas, liquified natural gas, or hydrogen.

9. The method of claim 2, wherein the product dispenser further comprises a printer configured to provide the transaction record as a paper transaction record.

10. The method of claim 3, wherein the data processor is further configured to transmit a digital transaction record to a mobile device of a user of the product dispenser.

11. A product dispenser, comprising:
a first housing including product dispensing components operable to dispense a product from the product dispenser;
a second housing including a data processor, a memory storing executable instructions, a display, a communication interface, and an image sensor, wherein the data processor is configured to execute the instructions stored in the memory to cause the data processor to perform operations comprising
initiating a dispensing operation to dispense the product via the dispensing components,
generating a request for a web page to be displayed via the display, the request generated in response to initiating the dispensing operation and the web page providing one or more selections of at least one good or service available within a dispensing environment in which the product dispenser is located,
causing the request to be transmitted via the communication interface to a point-of-sale system having a data processor configured to determine data characterizing the web page and content data contextually associated with the at least one good or service, the data characterizing the web page and the content data being dynamically generated in a memory of the point-of-sale system based on receiving the request for the web page, wherein the point-of-sale system is configured to generate and transmit the web page including the content data to the product dispenser,
receiving, via the communication interface, the web page including the content data from the point-of-sale system; and
causing the web page including the content data to be displayed via the display.

12. The product dispenser of claim 11, wherein responsive to the data processor receiving a selection of the at least one good or service via the displayed web page and causing the selection to be transmitted via the communication interface to the point-of-sale system, the data processor of the point-of-sale system is further configured to determine a transaction record including transaction data associated with the selection and cause the transaction record to be transmitted to the data processor of the product dispenser for display via the display.

13. The product dispenser of claim 12, wherein the transaction record further comprises transaction data associated with the dispensing operation.

14. The product dispenser of claim 13, wherein the transaction record further comprises an optically scannable element associated with the at least one good or service and/or the dispensing operation, the optically scannable element including one of bar code and a quick response code.

15. The product dispenser of claim 14, wherein the data processor of the point-of-sale system is configured to process the optically scannable element for redemption of the at least one good or service in the dispensing environment.

16. The product dispenser of claim 11, wherein the content data is formatted in one of a JavaScript object notation format or an extensible markup language format.

17. The product dispenser of claim 11, wherein the image sensor is configured to acquire image data characterizing one of a user of product dispenser and a vehicle positioned at the product dispenser and the communication interface is configured to transmit the image data to the data processor of the point-of-sale system, which once received the data processor of the point-of-sale system is further configured determine the content data based on the received image data.

18. The product dispenser of claim 11, wherein the product dispenser is configured to dispense at least one of electricity, petroleum fuel, diesel exhaust fluid, compressed natural gas, liquified natural gas, or hydrogen.

19. The product dispenser of claim 12, wherein the product dispenser further comprises a printer and the data processor of the product dispenser is further configured to provide the transaction record as a paper transaction record.

20. The product dispenser of claim 13, wherein the data processor of the point-of-sale system is further configured to transmit a digital transaction record to a mobile device of a user of the product dispenser.
